(19) United States
(12) Patent Application Publication
(10) Pub. No.: US 2015/0130816 A1
(43) Pub. Date: May 14, 2015

(54) COMPUTER-IMPLEMENTED METHODS AND SYSTEMS FOR CREATING MULTIMEDIA ANIMATION PRESENTATIONS

(71) Applicant: Avincel Group, Inc., Cambridge, MA (US)

(72) Inventors: Aymeric Vigneras, Belmont, MA (US); Etienne Leroy, Arlington, MA (US)

(73) Assignee: Avincel Group, Inc., Cambridge, MA (US)

(21) Appl. No.: 14/540,814

(22) Filed: Nov. 13, 2014

Related U.S. Application Data
(60) Provisional application No. 61/903,715, filed on Nov. 13, 2013.

(51) Int. Cl. G06T 13/00

(52) U.S. Cl. CPC G06T 13/00
USPC 345/473

(57) ABSTRACT

A computer-implemented method and system are provided for creating a multimedia animation presentation. The method includes the steps of: (a) receiving a plurality of visual content items; (b) analyzing the visual content items; (c) generating a set of technical instructions in real time for deterministically rendering a multimedia animation presentation from the visual content items based on a given theme; and (d) transmitting the technical instructions and the visual content items to a browser or mobile app on a user device to be executed by the browser or the mobile app to render the multimedia animation presentation and play it to the user on the user device.

### CROSS REFERENCE TO RELATED APPLICATION

This application claims priority from U.S. Provisional Patent Application No. 61/903,715 filed on Nov. 13, 2013 entitled MULTIMEDIA ANIMATION SYSTEM, which is hereby incorporated by reference.

### BACKGROUND

The present application relates generally to the field of media presentations and media organization and, more particularly, to methods and systems for creating multimedia animation presentations.

### BRIEF SUMMARY OF THE DISCLOSURE

In accordance with one or more embodiments, a computer-implemented method is provided for creating a multimedia animation presentation. The method includes the steps of: (a) receiving a plurality of visual content items; (b) analyzing the visual content items; (c) generating a set of technical instructions in real time for deterministically rendering a multimedia animation presentation from said visual content items based on a given theme; and (d) transmitting the technical instructions and the visual content items to a browser or mobile app on a user device to be executed by the browser or the mobile app to render the multimedia animation presentation and play it to the user on the user device.

A computer system in accordance with one or more embodiments comprises at least one processor, memory associated with the at least one processor, and a program supported in the memory for creating a multimedia animation presentation. The program contains a plurality of instructions which, when executed by the at least one processor, cause the at least one processor to: (a) receive a plurality of visual content items; (b) analyze the visual content items; (c) generate a set of technical instructions in real time for deterministically rendering a multimedia animation presentation from said visual content items based on a given theme; and (d) transmit the technical instructions and the visual content items to a browser or mobile app on a user device to be executed by the browser or the mobile app to render the multimedia animation presentation and play it to the user on the user device.

### BRIEF DESCRIPTION OF THE DRAWINGS

FIG. 1 illustrates elements of instructions for rendering a SmartShow in accordance with one or more embodiments.

FIG. 2 is a flow diagram illustrating an exemplary process for building a SmartShow in accordance with one or more embodiments.

FIG. 3 is a flow diagram illustrating another exemplary process for building a SmartShow in accordance with one or more embodiments.

FIG. 4 illustrates elements of instructions for rendering a SmartShow in accordance with one or more embodiments.

FIG. 5 is a flow diagram illustrating an exemplary push SmartShow process in accordance with one or more embodiments.

### DETAILED DESCRIPTION

Various embodiments disclosed herein are generally directed to a computer software system that enables users to quickly and easily create multimedia animation presentations (also referred to herein as ‘SmartShows’) from visual content items (which can comprise a picture, a video segment, or generally any graphical asset) and audio files (including, e.g., music, voice, and sounds).

In accordance with one or more embodiments, the system can automatically sort a multimedia collection and select the best images and video segments for a presentation with or without user involvement.

SmartShows can be created automatically or on demand. Users can share them privately or publicly with individuals or groups by various means, including, e.g., emails and social networking sites like Facebook, Twitter, Viber, etc. Users can watch SmartShows on virtually any computer or mobile device (on any type of operating system) with a web browser, preferably a modern browser.

In accordance with one or more embodiments, to prepare content for a SmartShow, the system: (1) collects visual content items (automatically or manually) from a variety of different sources (e.g., camera, cloud, hard drive, and social network), (2) analyzes the image content for similarity, quality, aesthetics, etc., (3) organizes the images (into albums or other organization schema); (4) automatically selects the best images from the organization schema; (5) analyzes the audio selected by the user (if any); and (6) proposes default audio, or uses no audio.

Based on this preparation, system builds the customized animation (SmartShow) on the fly. The system can tailor the animation to the audio (synchronization). The system can tailor the animation based on the contents of the visual content items. The system can tailor the size of the asset used in the SmartShow based on the type of user device. The system can also tailor the size of the asset used in the SmartShow according to network capabilities and bandwidth. If no audio is chosen by the user, the system can automatically pick one (according to image analysis, theme choice, etc.). A SmartShow can be also be built without any audio. The user can change the themes (unique visual styles), if desired, and the result is rendered on the fly. A SmartShow can be also built without any audio.

The system may be implemented as a stand-alone software, or in the context of a computer server system (distributed environment), in which one or more servers communicate with a plurality of user devices operated by the users of the system.

In the context of a computer server system, the user devices communicate with the system over a communications network. The communications network may comprise any network or combination of networks including, without limitation, the Internet, local area networks, wide area networks, wireless networks, cellular networks, or device-internal networks.

The user devices operated by users in the context of a stand-alone software or a computer system can comprise any computing device, including, without limitation personal computers (including desktop, notebook, and tablet computers), smart phones, cell phones, television and digital frames.

For example, when using a personal computer, users can build SmartShows locally or in the context of a computer server system. Users do not need to download specific software or players on their devices, with the exception of a web browser, to build or see a SmartShow. The system is compatible with a variety of browsers including, without limitation, Internet Explorer, Firefox, Safari, and Chrome.

When using a mobile device, users can build and view SmartShows locally or in the context of a computer server system. The user can access the system without network connection using a web browser and/or a similarly equipped mobile app. The SmartShow may be embedded in a mobile app using the same technology used by browsers.

A SmartShow can be saved on a computer server system and/or locally. A SmartShow can be shared by sharing a link or sending a SmartShow file.

The multimedia animation system in accordance with one or more embodiments allows users to create a movie-like experience without lengthy processing cycles. The system provides a unique way of creating and/or displaying a kind of movie without any pre-processing (rendering) and without the need to create a video file as an output.

This differs from standard video editing software in several ways. Video editing software produces a static video file. The video output file is generated in one of several common formats used for videos. The original assets to generate the video output cannot be retrieved from the output in their original format. The video output does not support changing any one original assets. The video has to be canceled and re-generated. To play the file, users need a specific video player that supports the format and codec of the video file created. In this traditional way, if users want to edit the video, they have to run the rendering process again to see the result of their changes.

SmartShows differ from standard slideshows or video slideshows in several ways. First, in accordance with one or more embodiments, SmartShows are interactive and editable. For instance, users can, on the fly, change the audio, theme, animation, transition, and/or template of the SmartShow. Users can also add, remove, or change visual content items in the SmartShow. The SmartShow adapts itself according to the changes made. Users can also interact with the SmartShow and stop the SmartShow, resume it, restart it, and download an image or video. Users can also “like” an image or video and share them on social networks. Users can zoom in and out and see the result of those interactions instantly. Users can make a selection of visual content items while the SmartShow is playing. Users can also change what is displayed and see the result with minimal rendering (generating a new instruction set-as discussed below).

SmartShows are also responsive in accordance with one or more embodiments. SmartShows can adapt the result according to visual content items and audio. For example, a SmartShow can behave differently if a person's face is in an image or not. The SmartShow can also, e.g., adapt effects according to the position of the face and key elements of the face.

SmartShows can also adapt the needed assets according to the user device's screen size and resolution. For example, it can adapt image size and customize animations.

SmartShows can adapt the needed assets according to the user device's capabilities, also by, e.g., adapting image size and customizing animations. SmartShows can recognize network capabilities and available bandwidth and then adapt the data stream to the available bandwidth and network capabilities (by stream size and speed). SmartShows can adapt the user device CPU and memory consumption according to device capabilities. SmartShows can also adapt to user taste, country, languages, etc.

The SmartShow output file is editable in accordance with one or more embodiments. Any original assets can be replaced individually without affecting the SmartShow output file. Any original assets can be replaced individually without the need of generating a new specific SmartShow output. Any original assets can also be retrieved from the SmartShow output file.

SmartShows are built quickly (e.g., within a few seconds) from a set of instructional parameters and associated data, including visual content items. These parameters are used to style, design, and run the SmartShow on the fly. These parameters can include, without limitation, animations, transitions effects, layout, animation-defining algorithms, durations of animations and effects, types of effects, themes, audio, audio analysis data, image analysis data, image metadata and image styling data (such as filters, borders, backgrounds, and overlays). SmartShows are defined by the unique combination of visual style and animation effects produced by these parameters.

SmartShows are built based on themes. A theme is a unique combination of animation effects, transitions, speed, timeline and visual styling (such as sizes, borders, filters, etc.).

Themes are unique combinations of visual style and animation effects that animate the visual content items selected by the user with effects that can depend on regions of interest in the visual content items. The region of interest can be defined for each image based on factors, including, without limitation, groups of people, horizontal and vertical orientation colors, physical locations, localization, subjects, position of the foreground, position of the horizon line, environment (e.g., mountain, forest, beach, city), positions of smiles, positions of eyes, position of image subject, and degree of blur. Effects are also influenced by factors including, without limitation, audio selected by the user, the rating of the image (which can be automatically-defined or user-defined), and the number of similar visual content items detected in the input media items. The influence on effects can include, but is not limited to, how long the image or video will be displayed, how much importance is given to this image, and visual emphasis.

An Animation is a collection of visual effects that can include, without limitation, geometric transformations (e.g., translation, rotation, scale, and distortion/skew), color effects (e.g., colorization and desaturation), transparency effects, blurs, and pixelizations.

Transitions define the effect applicable between animations effects. A Transition can comprise, without limitation, audio synchronization data (e.g., bars, beats, loudness, tempo), segments of high interest in the audio, audio assets, visual content items and user interactions.

Speed can comprise, without limitation, audio synchronization data (e.g., bars, beats, loudness, tempo), segments of high interest in the audio, audio assets, visual content items and user interactions.

A Scene is defined by a one animation effect, one style and a transition.

A Timeline is the organization of all the scenes in sequence.

The system uses the power of user's browser and/or the user's device to create the SmartShow on the fly. The system generally does what video editing software does in the processing phase, but displays the result in real time (as opposed to several minutes' delay). The result can be displayed at frame rates ranging from 30 frames per second to upwards of what is supported by the device (most of the time 60 frames per second).

An exemplary process for creating a SmartShow in the context of a remote application server is as follows (note that the process could be implemented in a remote server or locally on the user device):
(1) The Application server recognizes user device, if needed.
(2) The Application server communicates to the browser or the mobile app all technical instructions to render the SmartShow.
(3) The client device acknowledges and asks for content: visual content items and audio.
(4) The Application server communicates to the browser static assets related to the particular theme (such as background visual content items, frames, logos).
(5) The Application server communicates to the browser on the client device all visual content items and (optionally) any audio required by the SmartShow.
(6) The Browser starts to buffer media content in cache.
(7) As soon as there is sufficient data in the cache, the client device executes the technical instructions and renders the SmartShow in real time.

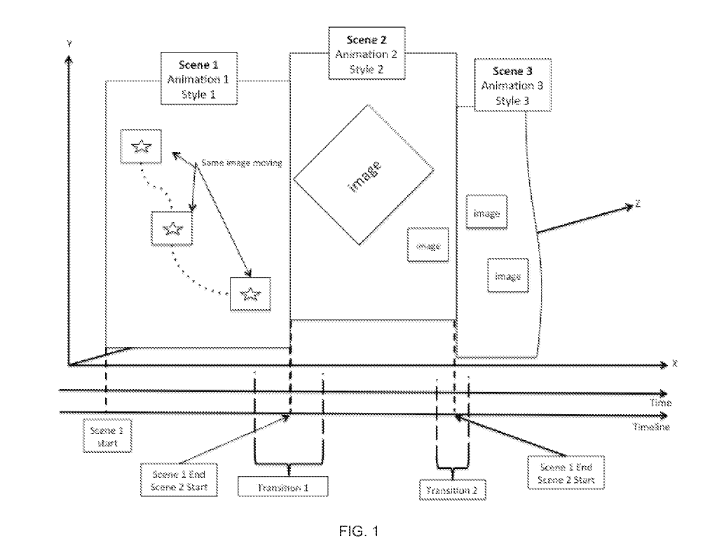

FIG. 1 illustrates elements of instructions for rendering a SmartShow. The instructions for a scene of a SmartShow include the following:
(1) The coordinates where and when each visual content item or group of visual content items need to be displayed on the screen.
(2) The positions defined by X, Y, Z and time according to a function such as, without limitation f(x, y, z, t), a Bezier curve, a group of tridimensional functions, a group of Bezier curve or any type of functions.
(3) A duration defined for a scene.
(4) The speed between positions, which is defined as follows:
   Animation duration=animation start−Animation end
   Position function
   Number of position=Position function/(Animation duration*frame per second)
   Reference point of image or group of visual content items which moves from one position to another (x, y, z) position (or stays at the same position) at a certain frame/second.
(5) Visual transformation data (such as initial size, crop, scale, skew, transparency) related to each effect of the animation.
(6) Duration of each particular effect of the animation.
(7) Starting and ending parameters (such as position, transparency).
(8) Screen frame rate (usually 60 frames per second).
(9) According to the animation, visual content item or group of visual content items has specific parameters along the function such as:
   a 3D position: (x, y, z) for each pixel
   a size
   Instructions to build surrounding environment (such as borders)
   Specific design layout (visual content items or mathematical instructions)
   Mathematical instructions to transition from the current effect to the next effect (such as rotation, scale, transparency, duration).
   Mathematical instruction to build effect orders (semi-random or based on image criteria).
(10) Stylistic changes to visual content items, if any (such as filters, borders).
(11) Instructions to create the timeline to sequence each animation and transition.

SmartShows can be saved and stored in a file so that they can be played offline. This file contains the visual content items, audio, statics assets selected for that specific SmartShow, and the theme and animation parameters. The system does not store the result of a long rendering like traditional video editing solutions, but instead the mathematical instructions and individual media content to allow a client device to recreate it.

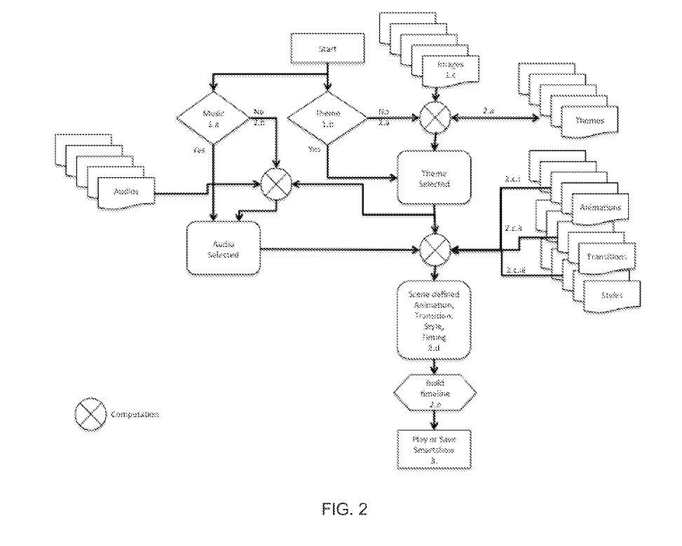

FIG. 2 is a flow diagram illustrating an exemplary process for building a SmartShow.

1. Input contains
a. Audio track (optional)
b. Theme (optional)
c. Media Items (visual content items)

2. SmartShow build
a. If no themes are provided, automatically select a theme
b. If no audio is provided, automatically select audio based on theme or use none
c. When theme and audio are defined
   i. Choose animation from a predefined set for each visual content item or group of visual content items, based on theme and/or visual content item data (orientation, aspect ratio), and/or audio analysis data
   ii. Choose style from a predefined set for each visual content item or group of visual content items, based on the theme and/or visual content items data (orientation, aspect ratio) and/or audio analysis data
d. Generate scenes: a scene is defined by one animation effect, one style and a transition
e. Generate timeline.

3. Output
a. An instruction file, which describes the SmartShow containing enough data to deterministically reproduce the SmartShow. This includes i visual content items, theme information, style parameters, animation parameters, transition parameters, and timeline.
b. The SmartShow is playable by any standard browser or native mobile application in the context of the SmartShow software.

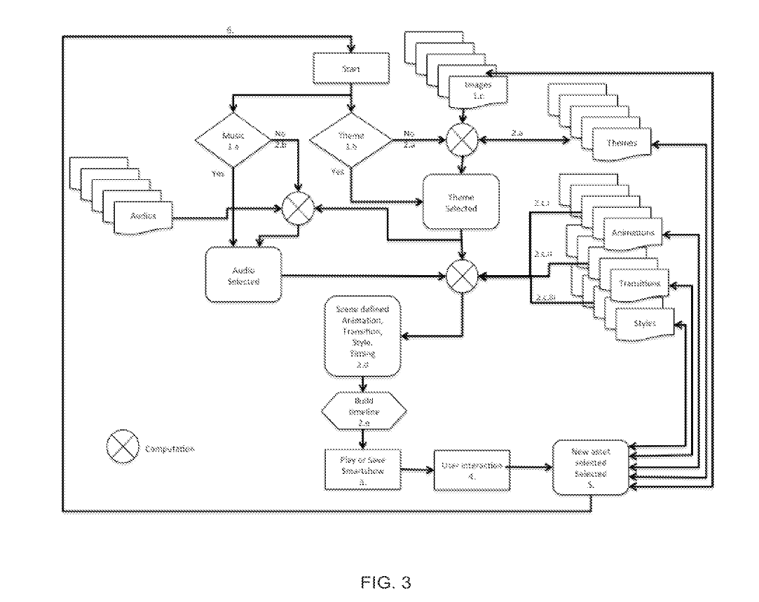

FIG. 3 is a flow diagram illustrating an exemplary process of user SmartShow interaction on assets.

1. Input contains
a. Audio track (optional)
b. Theme (optional)
c. Media Items (visual content items)

2. SmartShow build
a. If no themes are provided, automatically select a theme
b. If no audio is provided, automatically select audio based on theme or use none
c. When theme and audio are defined
   i. Choose animation from a predefined set for each image or group of visual content items, based on theme and/or image data (orientation, aspect ratio), and/or audio analysis data
   ii. Choose style from a predefined set for each image or group of visual content items, based on theme and/or image data (orientation, aspect ratio) and/or audio analysis data
d. Generate scenes: a scene is defined by a one animation effect, one style and a transition
e. Generate timeline.

3. Output
a. An instruction file, which describes the SmartShow containing enough data to deterministically reproduce the SmartShow. This includes visual content items, theme information, style parameters, animation parameters, transition parameters and timeline.
b. The SmartShow is playable by any standard browser in the context of the SmartShow software.

4. User interaction

5. New assets are determined manually or automatically

6. Assets are sent to the system and SmartShow resumes from previous time or restarts at the beginning.

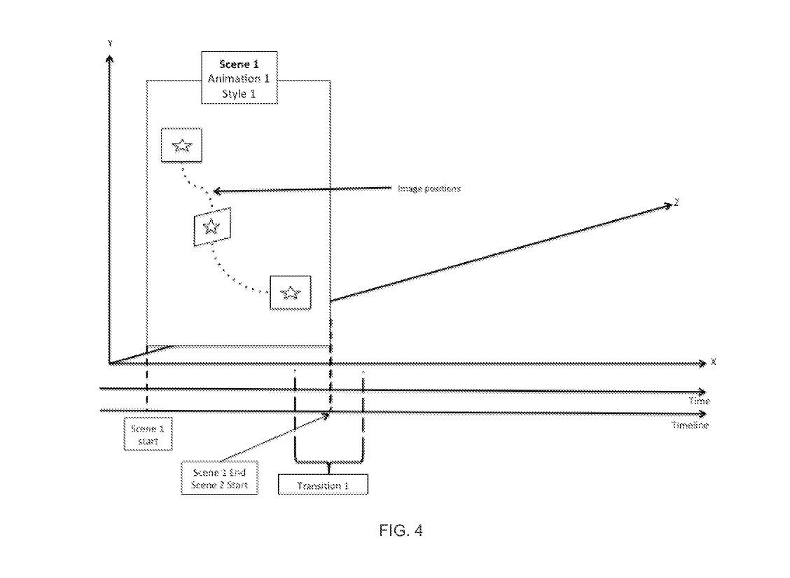

A SmartShow Instruction File includes a collection of animation and style data corresponding to each image or group of visual content items, transitions between these, speed and timeline as shown in FIG. 4.

SmartShows can use various common languages, including but not limited to the following exemplary languages: JavaScript, HTML5, and OpenGL.

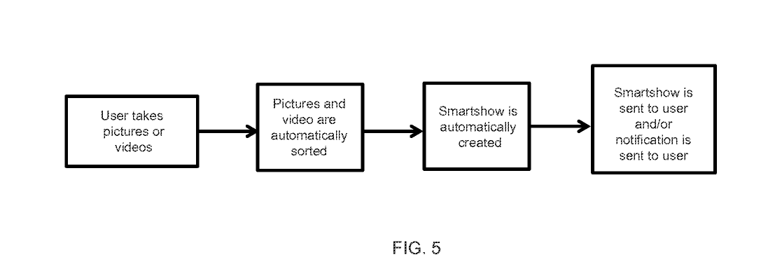

In accordance with one or more embodiments, SmartShows can be automatically pushed to users, particularly since the cost of producing a SmartShow is minimal on the system. The system can also make picture retrieval automatic. For example, as soon as a picture is taken with a mobile phone, the system retrieves the image and builds a SmartShow as illustrated in the flow diagram of FIG. 5. As soon as the content of a memory card is downloaded to a computer, the system retrieves the visual content items and build a SmartShow.

On a mobile Device, the system can automatically push a SmartShow made of the most recent visual content items taken by the user. The most recent moment of the user are automatically defined based on location and time. The system can select only the best picture and create a SmartShow automatically for the user. The user then can receive a notification that a SmartShow is ready.

In accordance with one or more embodiments, the system can push a SmartShow with relevant content for special events to the user. The system uses an algorithm to define a collection of visual content items and audio that are relevant for the user and then automatically builds a SmartShow.

Examples of relevant events can include, without limitation:
1. Mother's Day: the system can automatically push a SmartShow appropriate for Mother's Day (photos of mother and her children from the last year with her favorite music).
2. Birthday: the system can automatically push content appropriate for a birthday with a selection of the best photos of the targeted person and his/her friends.
3. New Years' Day: the system can automatically push a SmartShow including the best photo of the year for a specific group of people, e.g., friends/family.

The processes of the multimedia animation system described above may be implemented in software, hardware, firmware, or any combination thereof. The processes are preferably implemented in one or more computer programs executing on a programmable computer (which can be part of the computer server system or a user device) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network or not connected.

Accordingly, the foregoing description and drawings are by way of example only, and are not intended to be limiting.

What is claimed is:

1. A computer-implemented method of creating a multimedia animation presentation, comprising the steps of:
(a) receiving a plurality of visual content items;
(b) analyzing the visual content items;
(c) generating a set of technical instructions in real time for deterministically rendering a multimedia animation presentation from said visual content items based on a given theme; and
(d) transmitting the technical instructions and the visual content items to a browser or mobile app on a user device to be executed by the browser or the mobile app to render the multimedia animation presentation and play it to the user on the user device.

2. The method of claim 1, wherein step (c) comprises generating a set of technical instructions in real time for deterministically rendering a multimedia animation presentation from said visual content items and an audio file based on a given theme.

3. The method of claim 2, further comprising receiving the audio file as selected by the user for the multimedia animation presentation.

4. The method of claim 2, further comprising automatically selecting the audio file based on the visual content items for the multimedia animation presentation.

5. The method of claim 1, wherein the technical instructions include theme information, style parameters, animation parameters, transition parameters, and a timeline for said visual content items.

6. The method of claim 1, wherein the method is implemented in a remote computer system communicating with the user device over a communications network.

7. The method of claim 1, wherein the method is implemented in the user device.

8. The method of claim 1, wherein step (b) comprises analyzing the visual content items based on similarity, quality, and aesthetics.

9. The method of claim 1, further comprising automatically organizing the visual content items into an organization schema.

10. The method of claim 1, further comprising dynamically generating a new set of technical instructions in real time based on changes by the user to the multimedia animation presentation.

11. The method of claim 10, wherein said user changes include changes to the audio, theme, animation, transition, template, or visual content items of the multimedia animation presentation.

12. The method of claim 1, wherein the visual content items comprise video segments and/or still images.

13. The method of claim 1, wherein the multimedia animation presentation can be saved, shared, or liked by users.

14. The method of claim 1, further comprising adapting the set of technical instructions to optimize the multimedia animation presentation for the user device or network capabilities.

15. The method of claim 1, wherein step (d) comprises automatically pushing the technical instructions and the visual content items to a browser or mobile app on a user device.

16. The method of claim 15, wherein step (a) comprises automatically retrieving visual content items from the user device, and step (c) comprises generating technical instructions upon retrieval of the visual content items.

17. A computer system, comprising:
at least one processor;
memory associated with the at least one processor; and
a program supported in the memory for creating a multimedia animation presentation, the program containing a plurality of instructions which, when executed by the at least one processor, cause the at least one processor to:
(a) receive a plurality of visual content items;
(b) analyze the visual content items;
(c) generate a set of technical instructions in real time for deterministically rendering a multimedia animation presentation from said visual content items based on a given theme; and
(d) transmit the technical instructions and the visual content items to a browser or mobile app to be executed by the browser or the mobile app to render the multimedia animation presentation and play it to the user.

18. The system of claim 17, wherein the system comprises a remote computer system communicating with a user device over a communications network.

19. The system of claim 17, wherein the system comprises a user device.
